(19) United States
(12) Patent Application Publication
(10) Pub. No.: US 2006/0145499 A1
(43) Pub. Date: Jul. 6, 2006

(54) Expandible trailer

(75) Inventor: Edwin Lynn Boon, Surrey (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: K-Line Trailers Ltd., Langley (CA)

(21) Appl. No.: 11/253,763

(22) Filed: Oct. 20, 2005

Related U.S. Application Data
(60) Provisional application No. 60/619,929, filed on Oct. 20, 2004.

(51) Int. Cl. B62D 33/00

(52) U.S. Cl. 296/26.14

(57) ABSTRACT

An expanding trailer has two nesting expandable modules. By using hinged arms operating from a central rotating axis, the two modules are extended simultaneously. Previously a problem was that the modules on either side extend unevenly which causes balance problems. This design permits two opposed modules to extend evenly and simultaneously. Also a mechanism is provided to level the floor of the extended modules with the central floor once extended.

### CROSS-REFERENCE TO RELATED APPLICATIONS

This application claims priority from United States provisional application no. 60/619,929 filed Oct. 20, 2004, which is pending.

### TECHNICAL FIELD

The invention relates to the field of expandible trailers and more particularly expandible trailers having sections which extend from and retract into the trailer body.

### BACKGROUND

Expandible trailers in which modules extend from the trailer to expand the interior space when stationary and are retracted into the trailer body for travel are known. U.S. Pat. No. 5,291,701 Delacollette discloses a semitrailer in which the central box is fixed on the trailer chassis and two sliding boxes surround the fixed box and can be extended to form an expanded interior space and retracted for transport. U.S. Pat. No. 5,170,901 Bersani discloses an expandible container in which the sides are hinged to permit structures to be extended to expand the interior space. A difficulty with such prior structures is that the modules on either side may extend at different rates which causes imbalance in the trailer and possible upsetting of the trailer. Also in some designs the level of the floor is uneven as between the central and extended sections.

### SUMMARY OF INVENTION

The present invention provides an expanding trailer which has two nesting expandable modules. In particular the invention provides an expandible trailer, reversibly expandible from a first retracted position to a second extended configuration, the trailer comprising: a) a trailer body mounted on a trailer frame and having a floor and openings on opposed sides receive expansion modules; b) first and second nesting expansion modules couplably and simultaneously movable in opposed directions between a first retracted position wherein the first and second nesting modules are nested within the trailer body above the floor with the second module nested within the first module, to a second extended position, and wherein each module has a floor; c) means for supporting the modules in the extended configuration on the trailer frame; d) power means for selectively moving the modules between the retracted and extended positions; and e) means for lowering and raising the first and second modules to and from a position where the floors of the modules are level with the trailer body floor. The invention further provides a method of expanding a trailer.

By using hinged arms operating from a central rotating axis, supports on both ends of the two modules are extended simultaneously. This design permits two opposed modules to extend evenly and simultaneously while leveling the floor sections in the extended modules with the level of the floor in the central section.

### BRIEF DESCRIPTION OF DRAWINGS

In drawings which illustrate a preferred embodiment of the invention:

FIG. 1 is an elevation view of the trailer of the invention in expanded state;

FIG. 2 is a cross-sectional view taken along lines 2-2 of FIG. 5, with the retracted configuration in dotted outline;

FIG. 3 is a is a cross-sectional view taken along lines 3-3 of FIG. 1 while expanding;

FIG. 4 is an end view of the invention in collapsed state for transport;

FIG. 5 is an end view of the invention in expanded state;

FIG. 6 is a cross-sectional view of a second embodiment of the invention taken along lines 2-2 of FIG. 5 with the retracted configuration in dotted outline;

FIG. 7 is a cross-sectional view of an embodiment of the invention taken along lines 3-3 of FIG. 1 in extended configuration showing a first embodiment of the floor-leveling mechanism prior to leveling of the floors;

FIG. 8 is a cross-sectional view of the embodiment shown in FIG. 7 after leveling of the floors;

FIG. 9 is a cross-sectional view of an embodiment of the invention taken along lines 3-3 of FIG. 1 in extended configuration showing a second embodiment of the floor-leveling mechanism prior to leveling of the floors;

FIG. 10 is a cross-sectional view of the embodiment shown in FIG. 9 after leveling of the floors;

FIG. 11 is a detail end view of the lifting cross shaft used in the embodiment of the leveling mechanism shown in FIG. 7;

FIG. 12 is a detail end view showing the linking of three of the lifting cross shafts and used in the embodiment of the leveling mechanism shown in FIG. 7;

FIG. 13 is a detail end view of the lifting cross shaft used in the embodiment of the leveling mechanism shown in FIG. 7;

FIG. 14 is a detail elevation view of the rollers used in the invention; and

FIG. 15 is a side view of the rollers in the embodiment of the leveling mechanism shown in FIG. 9.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

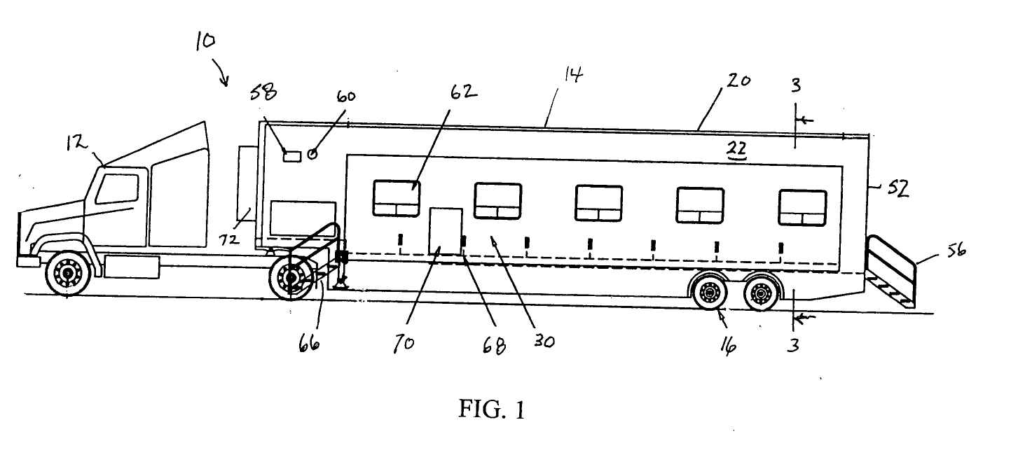

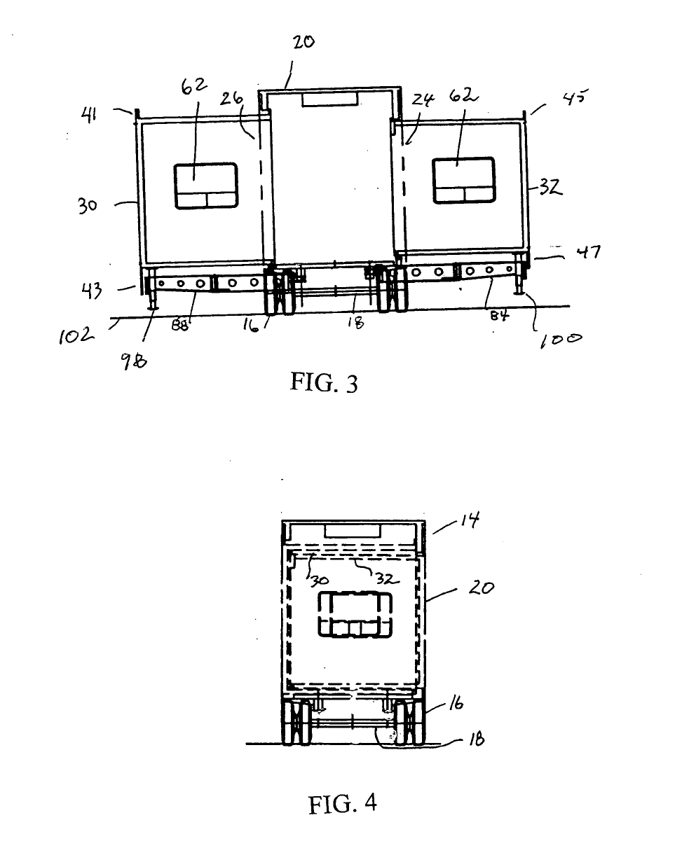

With reference to FIGS. 1-5, a semi-trailer truck 10 has a truck tractor 12 connected to trailer 14. Trailer 14 has a chassis 15 to which wheels 16, axle 18 and cargo box 20 are fixed to the chassis. Vertical sides 22 of cargo box 20 have cut-out openings 24, 26 to receive expandible modules 30, 32. Modules 30, 32 have top panels 34, 36, bottom panels 38, 40, side panels 42, 44 and ends 46, 48, 50, 52, and are open to the interior of cargo box 20. Side panels 42, 44 have flanges 41, 43, 45, 47 which seal the openings 24, 26 when the modules are retracted. Module 32 is smaller than module 30 so that it fits within module 30 when retracted (FIG. 4).

End 52 of cargo box 20 has door 54 and removable steps 56, flood lights 58 and stair lights 60. Windows 62, door 64 and removable steps 66 are provided on module 30. Electrical box 68 with hinged access panel 70 is provided for electrical, telephone and computer connections. An air conditioning unit is provided at 72.

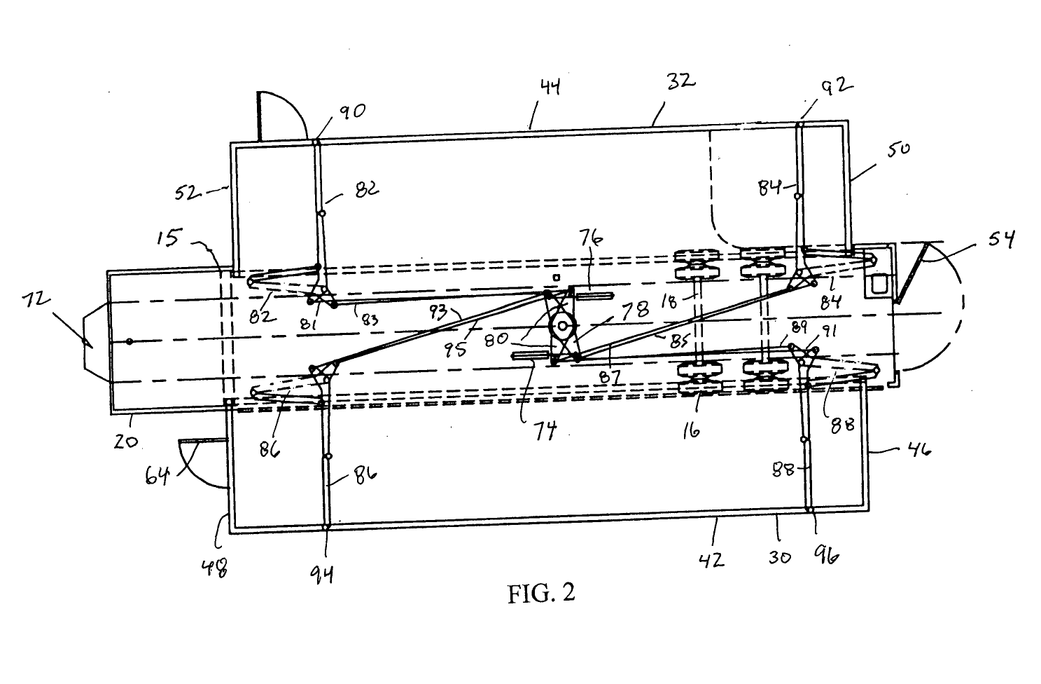

A first embodiment of the mechanism for extending and retracting modules 30, 32 is shown in FIG. 2. Hydraulic cylinders 74, 76 are connected to pivoting element 78 in the extended position. Reference numeral 80 shows pivoting element 78 in the retracted position. Element 78 is connected to hinged support arms 82, 84, 86, 88 by rods 81, 85, 91 and 93. In the retracted position, wherein hinged support arms 82, 84, 86, 88 are shown in dotted outline, the connecting rods are in the positions designated as rods 83, 87 and 89, 95. The ends of hinged support arms 82, 84, 86, 88 are pivotally secured to sides 42, 44 of modules 30, 32 at 90, 92, 94, 96. Retracting cylinders 74, 76 causes hinged support arms 82, 84, 86, 88 to fold and retract modules 30, 32 into cargo box 20 while extending cylinders 74, 76 causes hinged support arms 82, 84, 86, 88 to unfold and extend modules 30, 32 from cargo box 20. Once modules 30, 32 are extended, the floors are leveled as described below and support legs 98, 100 are lowered into contact with the ground 102.

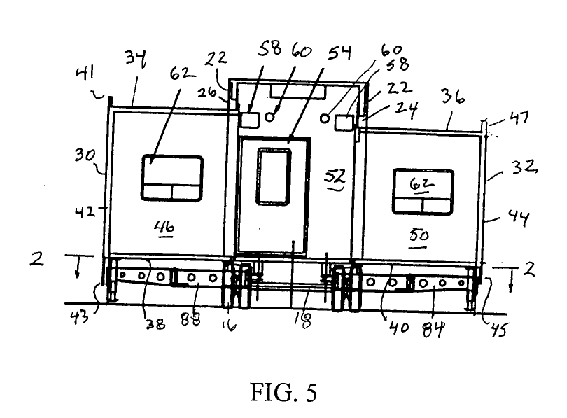

In operation the modules 30, 32 are extended from the position shown in FIG. 4 when the trailer is stationary by activating hydraulic cylinders 74, 76 which unfold support arms 82, 84, 86, 88 and causes modules 30, 32 to extend to the position shown in FIG. 5. The floors are then leveled and support legs lowered. The process is reversed to retract the modules which are locked in the retracted position for transport.

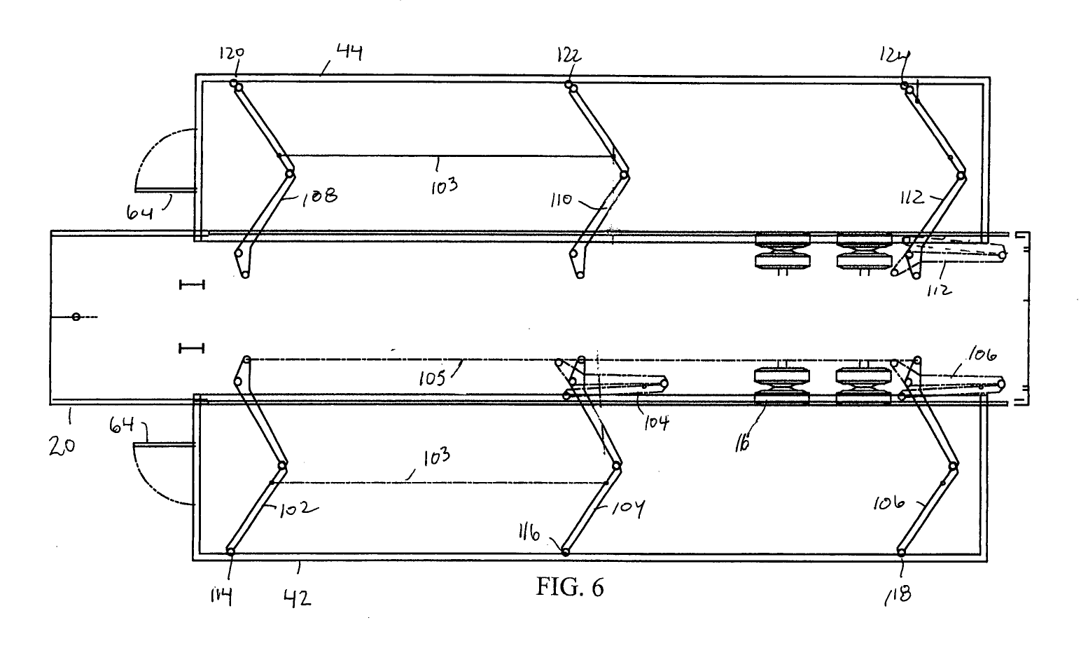

FIG. 6 illustrates an embodiment having three pairs of hinged support arms 102, 104, 106, 108, 110, 112 in the extended position, with arms 104, 106, 112 shown in dotted outline in the retracted position. Hinged support arms 102, 104, 106, 108, 110, 112 are pivotally connected to the sides 42, 44 of modules 30, 32 at 114, 116, 118, 120, 122, 124. This embodiment may also use linkages 103, 105 to ensure that the arms deploy in unison to keep the modules square.

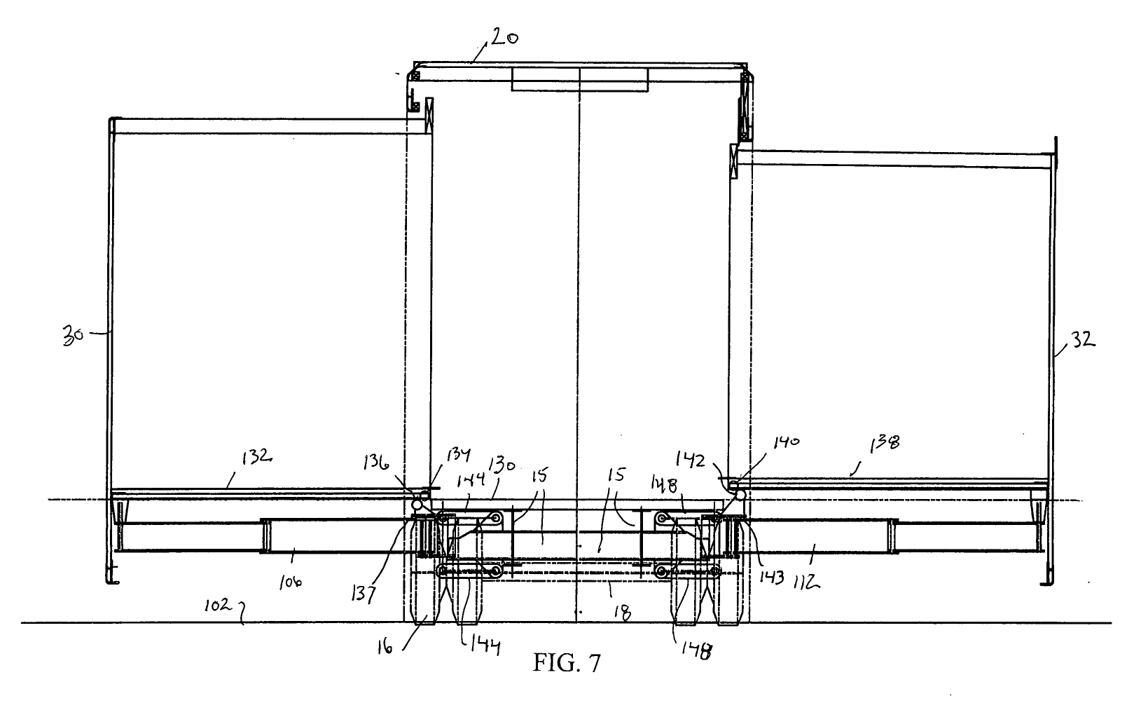

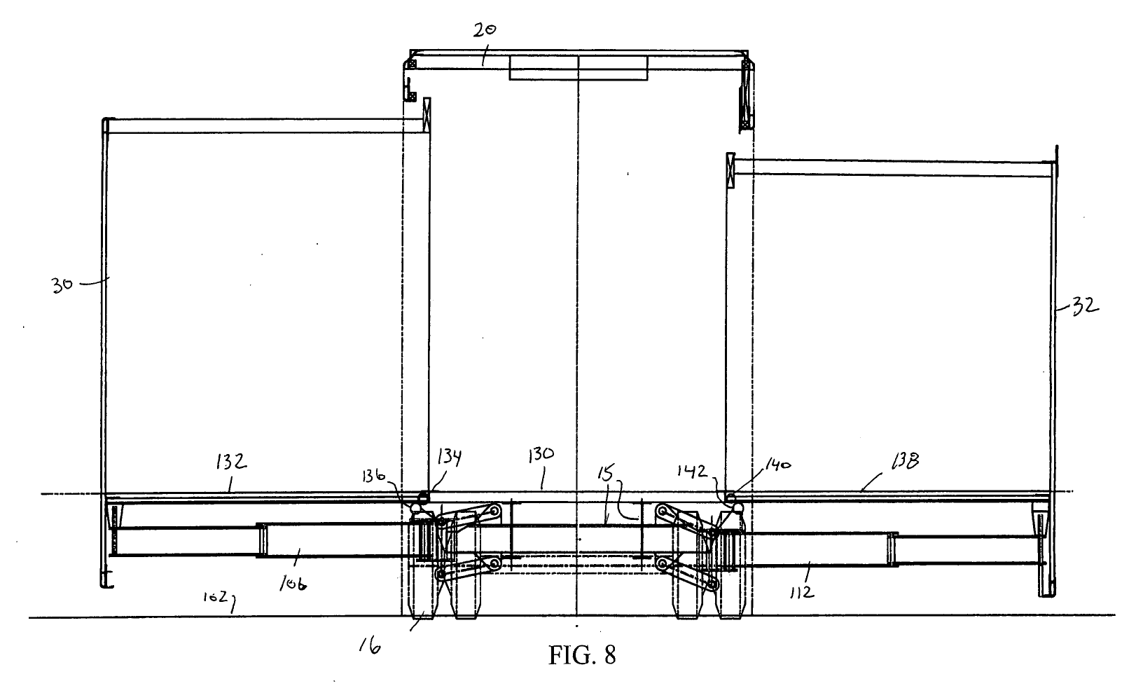

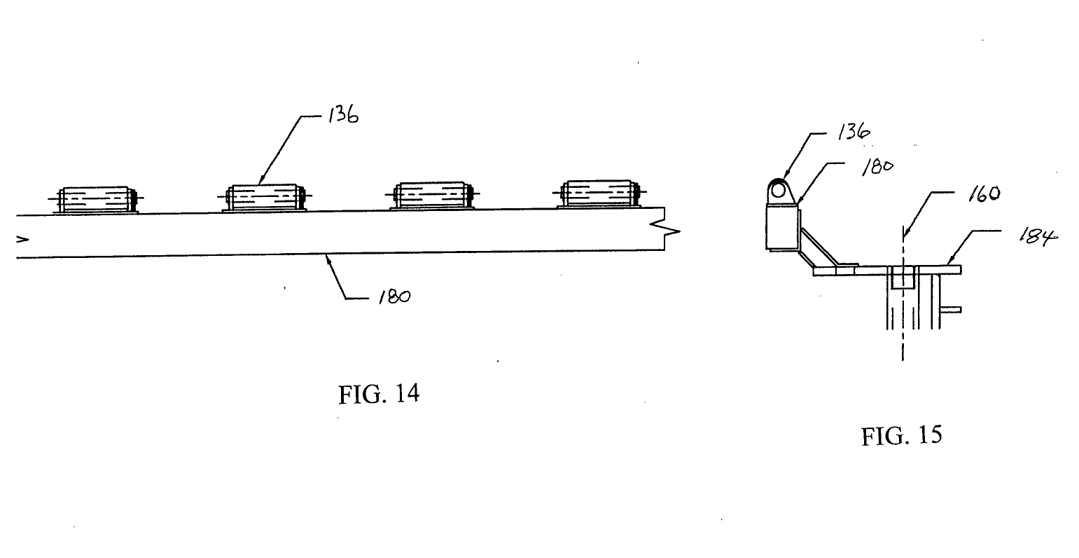

A first embodiment of the mechanism for leveling the floor of the extended trailer is shown in FIGS. 7 and 8. Cargo box 20 has floor 130. Larger module 30 has floor 132 which extends on rollers 134, mounted on the lower surface of floor 132, and roller 136 mounted on arm 106. Rollers 134 roll on floor 130 as module 30 extends and so are above floor 130 as it extends. Smaller module 32 has floor 138 which extends on rollers 140, mounted on the lower surface of floor 138, and rollers 142 mounted on arm 112. As module 32 is nested inside module 30, rollers 142 are located above rollers 136 and rollers 140 roll on floor 132 when module 32 is nested inside module 30. Rollers 134 and 140 are preferably a series of nylon rollers mounted on the lower inboard edges of modules 30, 32. Rollers 136, 142 are each formed as a series of rollers 136 and are mounted on a support bar 180 which runs the length of the box (FIG. 14). Support bar 180 is mounted on box structures 137, 143 which are secured to arms 106, 112, are raised and lowered with arms 106, 112 as described below and are open to allow pivoting of the arms. Corresponding roller structures are associated with each pair of support arms. The longitudinal support bar 180 carries the inboard weight of the modules 30, 32 while arms 106, 112 carry the outboard weight. As the modules 30, 32 contract, the support arms 106, 112 close in on the rollers 136, 142 and the modules tip up slightly onto the rollers 134, 140 to avoid scraping the floors on the last part of the travel of the modules as the center of gravity shifts.

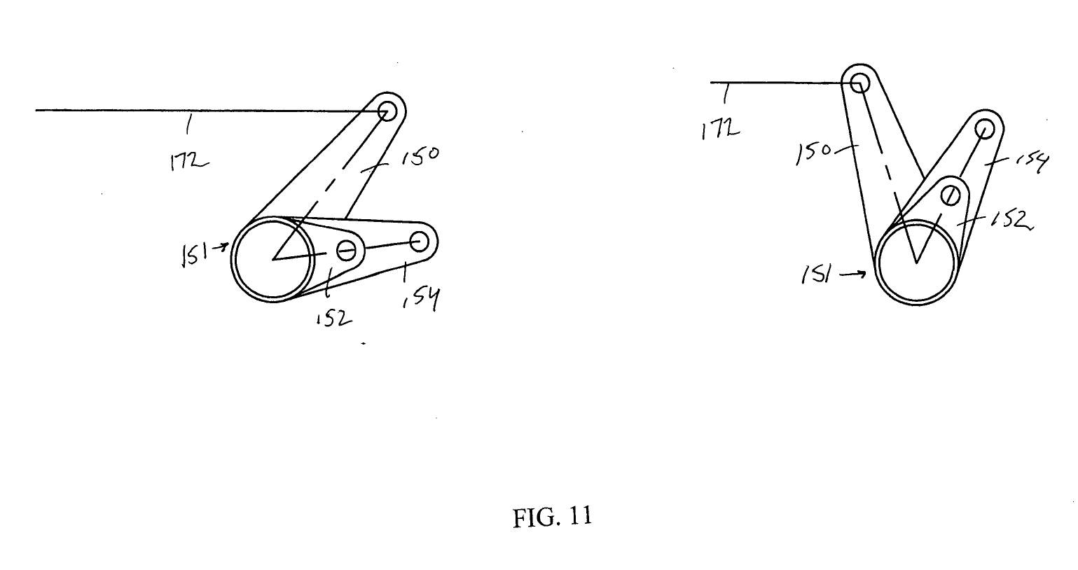

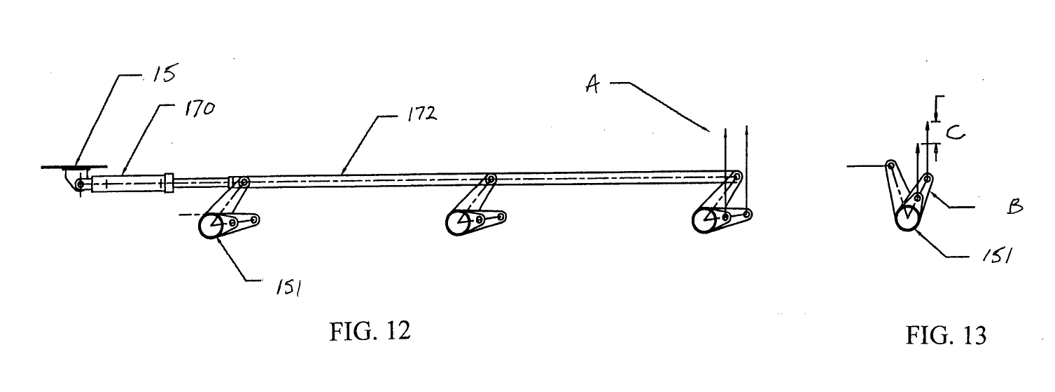

Parallelogram linkages 144, 148 are pivotally connected at their inner ends to the trailer chassis 15 and at their outer ends to support arms 106, 112 and box structures 137, 143. In the retracted transport configuration the linkages 144, 148 are parallel to the ground 102 for increased ground clearance as shown in FIG. 7. After the modules have been extended, the linkages 144, 148 are pivoted by hydraulic cylinder 170 attached to frame 15 or electric power to lower arms 106 and 112 so that floors 132, 130 and 138 are level as shown in FIG. 8. Arms 102, 104, 106 are lowered a lesser amount than arms 108, 110, 112 by using cross shafts 151 as shown in FIGS. 11-13 having welded thereto a drive lever 150 driven by hydraulic cylinder 170 through link bar 172 and raining levers 152, 154 connected to linkages 144, 148. One cross shaft 151 is used per left and right pair of support arms i.e. one for arms 106 and 112, a second for 104, 110 and a third for 102, 108. The cross-shaft is rotated about 90 degrees, driven by the hydraulic cylinder 170 or electric actuator, with the three cross-shafts 151 tied together by a lever and link bar 172 so that they operate in unison. As shown in FIGS. 12, 13, this arrangement provides for a differential in height increase C between the position A in FIG. 12 and position B in FIG. 13. In the preferred embodiment the vertical lift is about 3.5 inches for arm 106 and 7 inches for arm 112.

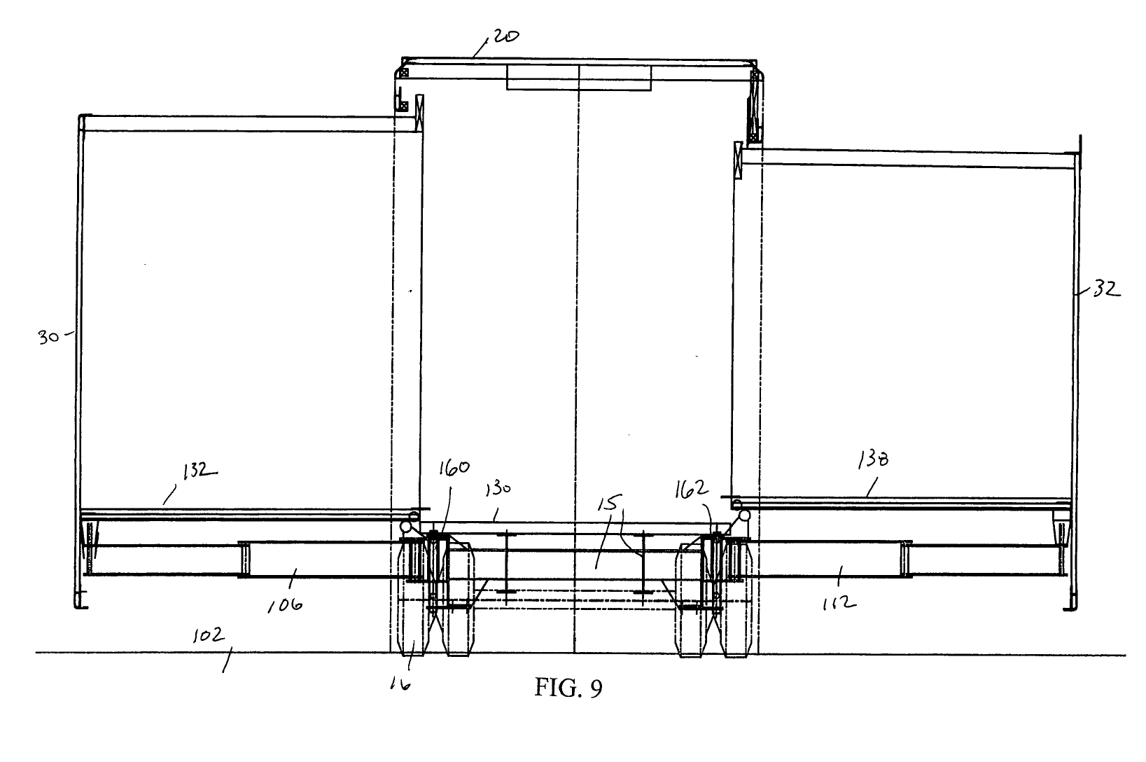

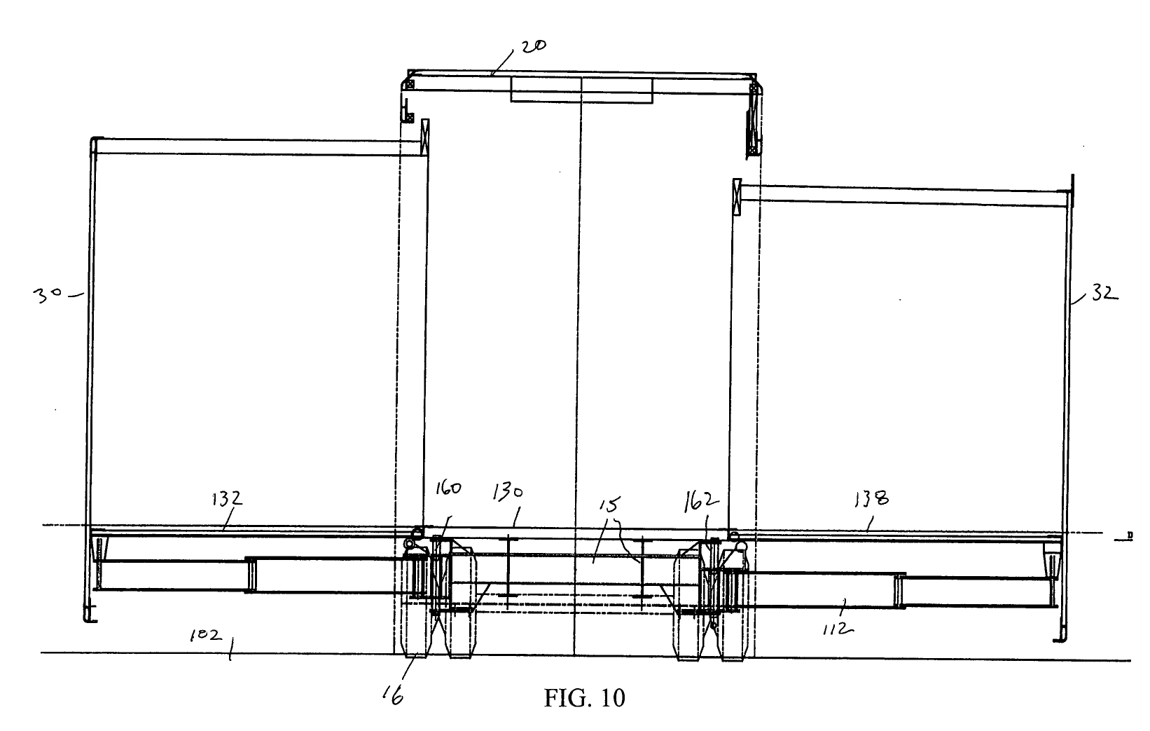

A second embodiment of the mechanism for leveling the floor of the extended trailer is shown in FIGS. 9 and 10. In this embodiment the support arms 106, 112 slide up and down on king posts 160, 162. Each pair of support arms has a pair of king posts. The raising and lowering of the arms is carried out by hydraulic or electric actuators which are configured to provide the appropriate amount of vertical travel for each support arm to achieve a level surface across the three floors 132, 130, 138 as shown in FIG. 10.

As will be apparent to those skilled in the art in the light of the foregoing disclosure, many alterations and modifications are possible in the practice of this invention without departing from the spirit or scope thereof.

What is claimed is:

1. An expandible trailer, reversibly expandible from a first retracted position to a second extended position, said trailer comprising:
a) a trailer body mounted on a trailer frame and having a floor and openings on opposed sides to receive expansion modules;
b) first and second nesting expansion modules couplably and simultaneously movable in opposed directions between a first retracted position wherein said first and second nesting modules are nested within said trailer body above said trailer body floor with said second module nested within said first module, to a second extended position, and wherein each module has a floor;
c) means for supporting said modules in said extended configuration on said trailer frame;
d) power means for selectively moving said modules between said retracted and extended positions;
e) means for lowering and raising said first and second modules when in said extended position to and from a position where said floors of said modules are level with said trailer body floor.

2. The expandible trailer of claim 1 wherein said means for supporting said modules comprise hinged arms mounted at their inner ends on said trailer frame and supporting on their outer ends said modules and linked to a central rotating axis for extending and retracting.

3. The expandible trailer of claim 1 wherein said power means comprises a hydraulic cylinder.

4. The expandible trailer of claim 2 wherein said means for supporting said modules in said extended position on said trailer frame comprise a plurality of pairs of hinged support arms, each hinged support arm extendible from a retracted to an extended position, one hinged support arm in each pair supporting said first nested module and the second hinged support arm in each pair supporting said second nested module and wherein said first and second hinged support arms in each pair are coupled for simultaneous movement in opposed directions.

5. The expandible trailer of claim 4 wherein first and second hinged support arms in each of two pairs are coupled for simultaneous movement in opposed directions.

6. The expandible trailer of claim 4 wherein said first and second hinged support arms in each pair are coupled for simultaneous movement in opposed directions by means of a pivoting element linked to each of said first and second hinged support arms and driven by a hydraulic cylinder.

7. The expandible trailer of claim 1 further comprising rollers mounted on said frame for movably supporting said first and second nesting expansion modules during movement between said first retracted position wherein said first and second nesting modules are nested within said trailer body above said floor with said second module nested within said first module, to said second extended position.

8. The expandible trailer of claim 8 wherein said first and second nesting expansion modules each comprise rollers mounted adjacent inner edges thereof for contacting a supporting surface during movement.

9. The expandible trailer of claim 1 wherein said means for lowering and raising said first and second modules to and from a position where said floors of said modules are level with said trailer body floor comprises pivotting support means adapted to raise and lower said first and second modules simultaneously but by different amounts.

10. The expandible trailer of claim 1 wherein said means for lowering and raising said first and second modules to and from a position where said floors of said modules are level with said trailer body floor comprises a vertical pin on which said modules are raised and lowered by power means simultaneously but by different amounts.

11. A method of expanding a trailer having a trailer body mounted on a frame and having a floor and comprising two nesting modules, each having a floor, mounted for opposed movement in said trailer body between retracted and extended configurations comprising: extending said two nesting modules simultaneously in opposite directions, at levels such that said floors of said modules are respectively higher than the level of said trailer body floor; and once extended beyond said trailer body floor, lowering said modules simultaneously until the levels of said trailer body floor and said modules' floors are generally even.

12. The method of claim 11 wherein said trailer comprises means for supporting said modules comprising hinged arms mounted at their inner ends on said trailer frame and supporting on their outer ends said modules and linked to a central rotating axis for extending and retracting motion.

13. The method of claim 12 wherein said modules are supported in said extended configuration on said trailer frame by a plurality of pairs of hinged support arms, each hinged support arm extendible from a retracted to an extended position, one hinged support arm in each pair supporting said first nested module and the second hinged support arm in each pair supporting said second nested module and wherein said first and second hinged support arms in each pair are coupled for simultaneous movement in opposed directions.

14. The method of claim 13 wherein first and second hinged support arms in each of two pairs are coupled for simultaneous movement in opposed directions.

15. The method of claim 14 wherein said first and second hinged support arms in each pair are coupled for simultaneous movement in opposed directions by means of a pivoting element linked to each of said first and second hinged support arms and driven by a hydraulic cylinder.

16. The method of claim 11 wherein said trailer comprises rollers mounted on said frame for movably supporting said first and second nesting modules during movement between said first retracted configuration wherein said first and second nesting modules are nested within said trailer body above said floor with said second module nested within said first module, to said second extended configuration.

17. The method of claim 16 wherein said first and second nesting modules each comprise rollers mounted adjacent inner edges thereof for contacting a supporting surface during movement.

18. The method of claim 11 wherein said trailer comprises means for lowering and raising said first and second modules to and from a position where said floors of said modules are level with said trailer body floor by means of pivoting support means adapted to raise and lower said first and second modules simultaneously but by different amounts.

19. The method of claim 11 wherein said trailer has means for lowering and raising said first and second modules to and from a position where said floors of said modules are level with said trailer body floor by means of a vertical pin on which said modules are raised and lowered by power means simultaneously but by different amounts.
